(19) United States
(12) Patent Application Publication
(10) Pub. No.: US 2026/0168579 A1
(43) Pub. Date: Jun. 18, 2026

(54) SWITCHING VALVE AND SWITCHING UNIT FOR SWITCHING AT LEAST TWO FLUID CHANNELS

(71) Applicant: MANN+HUMMEL GmbH, Ludwigsburg (DE)

(72) Inventor: Benedikt WELLER, Steinheim (DE)

(21) Appl. No.: 19/533,981

(22) Filed: Feb. 9, 2026

Related U.S. Application Data
(63) Continuation of application No. PCT/EP2024/073535, filed on Aug. 22, 2024.

(30) Foreign Application Priority Data
Aug. 23, 2023 (DE) 10 2023 122 549.9

(51) Int. Cl. F16K 3/24; F16K 31/06; F16K 35/00

(52) U.S. Cl. CPC F16K 3/24; F16K 31/0668; F16K 35/00

(57) ABSTRACT

A switching valve includes a housing with valve openings configured to be connected to fluid channels and a piston movable in the housing to control fluid flow between the valve openings and the fluid channels. A first restoring spring subjects the piston to a restoring force. A switching unit moves the piston against the restoring force from a first switching position into a second switching position and back from the second switching position. The piston is held without an energy supply in both first and second switching positions. The switching unit has a base ring with alternating guide grooves and holding ribs and an actuator guided in the guide grooves that moves the piston and has first control surfaces. A switching ring is movable in the base ring and has second control surfaces complementary to the first control surfaces. A second restoring spring supports the switching ring at the actuator.

### CROSS-REFERENCE TO RELATED APPLICATIONS

This application is a continuation application of international application No. PCT/EP2024/073535 having an international filing date of Aug. 22, 2024, and designating the United States, the international application claiming a priority date of Aug. 23, 2023, based on prior filed German patent application No. 10 2023 122 549.9, the entire contents of the aforesaid applications being incorporated herein by reference.

### BACKGROUND

The invention concerns a switching valve for switching at least two fluid channels as well as a switching unit for a switching valve.

Electrically switched switching valves for switching a hydraulic flow gallery with at least two flow channels are known. Conventional valves hold the open position against the oil pressure and thus exhibit a defined current consumption depending on the holding force in the open or closed position.

DE 20 2005 011 092 U1 describes a detent bolt with a locking pin axially drivable by means of a rotary movement. The radial pin may be locked in at least one axial end groove with reduction of the force of a spring in such a way that, prior to the return rotation, the radial pin must be axially displaced and thereby unlocked by axially pulling or pushing against the force of the spring. For moving the locking pin into its position which locks or releases at least two components, a radial screw slit/radial pin guide is provided between the locking pin and the housing sleeve.

DE 20 2008 013 348 U1 discloses a lock bolt with locking mechanism in which the actuation of the lock bolt for the locking action or the releasing action is always carried out in only one single actuation direction either by pushing or by pulling. The lock bolt includes essentially a type of “ballpoint pen mechanism” as displacement and arresting mechanism for a blocking action in the working and rest position. In this way, the locking pin is actuated only by pressing (or only by pulling) opposite to the force of a spring or by means of the force of a spring. The displacement and arresting mechanism corresponds in its function substantially to the sliding guide of a ballpoint pen guide. Thus, a conventional switching mechanism is provided as it is used, for example, in ballpoint pens and the like.

DE 20 2009 014 685 U1 discloses a sliding arrangement, for example push-out device for drawers, sliding doors, hinged doors etc., with a push-out arrangement including a sliding piece that is adjustable between an inserted position and a pushed-out position by means of a spring element. The sliding piece is adjustable along a first adjustment travel by a spring load and along a subsequent second adjustment travel without spring load in a freewheel action of the push-out device.

### SUMMARY

It is an object of the invention to provide an efficient switching valve for switching at least two fluid channels.

A further object of the invention is to provide an efficient switching unit for a switching valve.

The aforementioned object is solved according to an aspect of the invention by a switching valve for switching at least two fluid channels, including at least a valve housing in which a piston is arranged so as to be movable in an axial direction for controlling a fluid flow between at least two valve openings, which, in use as intended, are connected in fluid communication to the fluid channels; a first restoring spring by means of which the piston, in operation as intended, is subjected to a restoring force in axial direction; and a switching unit which is configured to move the piston, against the restoring force, from at least one first switching position into at least one second switching position and hold it, as well as return it from the at least one second switching position into the at least one first switching position, wherein the piston is held without a supply of energy in the at least one first switching position and the at least one second switching position.

According to a further aspect of the invention, the further object is solved by a switching unit for a switching valve, including at least a base ring with guide grooves and holding ribs arranged alternatingly at the inner circumference; an actuator which is guided in the base ring in axial direction in the guide grooves and by means of which a piston is movable in axial direction and which includes first control surfaces slanted in circumferential direction; a switching ring which is guided in the base ring and movable in axial direction and includes second control surfaces complementary to the first control surfaces in circumferential direction and provided for contacting the first control surfaces; and a second restoring spring by means of which the switching ring is supported at the actuator in axial direction.

Embodiments of the invention result from the description and the accompanying drawings.

According to an aspect of the invention, a switching valve for switching at least two fluid channels is proposed, including at least a valve housing in which a piston is arranged so as to be movable in an axial direction for control of a fluid flow between at least two valve openings, which, in use as intended, are connected in fluid communication to the fluid channels; a first restoring spring by means of which the piston, in operation as intended, is subjected to a restoring force in axial direction; and a switching unit which is configured to move the piston, against the restoring force, from at least one first switching position into at least one second switching position and hold it, as well as return it from the at least one second switching position into the at least one first switching position. In this context, the piston is held without a supply of energy, for example electrical or magnetic energy, in the at least one first switching position and the at least one second switching position.

The present invention relates to an electrically switched switching valve which actively switches a hydraulic flow gallery. In this context, the switching valve connects two or more fluid channels to each other. For this purpose, the two fluid channels which are to be connected are both intersected by a switching channel. The switching valve is inserted into this switching channel. The switching valve includes at least one piston, a restoring spring, and a switching unit which makes it possible to hold at least one first switching position and at least one second switching position of the switching valve without a supply of energy, for example electrical or magnetic energy.

The proposed switching valve includes thus end positions held without current and therefore saves energy.

Further, it is conceivable to use the switching valve also for switching and/or distributing gas flows.

According to an embodiment of the switching valve, the switching unit may be designed to move the piston from the at least one first switching position into the at least one second switching position and back by action of a control pin movable in axial direction. By means of the control pin, the switching process may be initiated and controlled. When the switching process is initiated, the transition from one switching position to the other switching position is realized by the internal mechanism of the switching unit.

According to an embodiment of the switching valve, the control pin may be coupled to a drive, for example an electromagnetic drive. The control pin may be controlled and moved, for example, by an electromagnetic actor, but also may be controlled and moved hydraulically.

According to an embodiment of the switching valve, the switching unit may include at least one base ring with guide grooves and holding ribs arranged alternatingly at the inner circumference; an actuator which is guided in the guide grooves in the base ring in axial direction and by means of which the piston is movable in axial direction and which includes first control surfaces slanted in circumferential direction; a switching ring which is guided in the base ring and is movable in axial direction and includes second control surfaces complementary to the first control surfaces in circumferential direction and provided for contacting the first control surfaces; and a second restoring spring by means of which the switching ring is supported at the actuator in axial direction. By means of the switching unit, the piston may thus be switched back and forth between the first switching position and the second switching position by control through the control pin.

According to an embodiment of the switching valve, upon actuation of the control pin a simultaneous axial and rotary movement of the actuator about the longitudinal axis may be carried out, whereby the actuator is lifted out of the guide grooves and is held in the at least one second switching position by holding ribs which are arranged at the base ring and extend in axial direction.

The simultaneous axial and rotary movement of the actuator may be realized assisted by the restoring force of the first restoring spring. Due to the slanted control surfaces, upon renewed actuation of the switching ring a rotary movement of the actuator may be beneficially effected again by the control pin and the actuator may be lifted out of the holding ribs. In this way, the actuator may be returned into the at least one first switching position due to the restoring force of the first restoring spring.

According to an embodiment of the switching valve, the second control surfaces of the switching ring may be configured wedge-shaped at least in sections in the circumferential direction. The rotary movement of the actuator may be effected in this way.

According to an embodiment of the switching valve, the switching ring may include radially projecting guide noses which engage as intended the guide grooves of the base ring. In this manner, the switching ring may be laterally guided in the guide grooves of the base ring during its movement in axial direction.

According to an embodiment of the switching valve, the holding ribs may include locking surfaces at their axial free ends in which the actuator is held in the at least one second switching position. The first control surfaces of the actuator may thus interact with the locking surfaces in order to hold the actuator in the second switching position.

According to an embodiment of the switching valve, the actuator may include guide elements at a circumference which extend in axial direction and engage as intended the guide grooves of the base ring. Thus, the actuator may also be laterally guided upon a movement in axial direction.

According to an embodiment of the switching valve, the guide elements may include the first control surfaces at their axial free ends. The first control surfaces of the actuator may thus interact with the locking surfaces of the holding ribs in order to hold the actuator in the second switching position.

According to an embodiment of the switching valve, the locking surfaces may include locking noses arranged in circumferential direction at which the guide elements are locked in the at least one second switching position. In this manner, the actuator may be held in the second switching position.

According to an embodiment of the switching valve, the holding ribs at their axial free end may include locking surfaces adjoining each other in circumferential direction and arranged at different levels in the axial direction. It is thus possible to adjust a new switching position in the manner of a step switching action with each further switching impulse by the control pin.

According to an embodiment of the switching valve, the piston and the actuator may each have a bore for compensation of a fluid volume upon movement of piston and actuator. In this way, it may be prevented that the enclosed fluid volume hinders the movement of the piston and of the actuator.

According to an embodiment of the switching valve, the switching ring may include a receptacle and/or the actuator an inner section for guiding the second restoring spring. In this way, the second restoring spring may be securely guided during the movement of the actuator.

According to a further aspect of the invention, a switching unit for a switching valve is proposed, including at least a base ring with guide grooves and holding ribs arranged alternatingly at the inner circumference; an actuator which is guided in the guide grooves in the base ring in axial direction and by means of which the piston is movable in axial direction and which includes first control surfaces slanted in circumferential direction; a switching ring which is guided in the base ring and is movable in axial direction and includes second control surfaces complementary to the first control surfaces in circumferential direction and provided for contacting the first control surfaces; and a second restoring spring by means of which the switching ring is supported at the actuator in axial direction.

The switching unit including base ring, actuator, switching ring, and restoring spring could be used also as a retrofitting solution in order to convert a standard valve to a switching valve with currentless end position.

In an alternative embodiment of the switching valve, the contour of the base ring is formed in the valve housing, for example formed as one piece therewith.

### BRIEF DESCRIPTION OF THE DRAWINGS

Further advantages result from the following detailed description and accompanying drawings. In the drawings, embodiments of the invention are illustrated. The drawings and the detailed description disclose numerous features in combination. A person of skill in the art will consider the features expediently also individually and combine them to expedient further combinations.

FIG. 1 shows an isometric illustration of a switching valve for switching at least two fluid channels according to an embodiment of the invention.

FIG. 2 shows an exploded illustration of the switching valve.

FIG. 3 shows an enlarged exploded illustration of a part of the switching valve with a switching unit according to an embodiment of the invention.

FIG. 4 shows in section illustration the switching valve mounted in a valve block in a second switching position.

FIG. 5 shows in section illustration the switching valve mounted in a valve block in a first switching position.

FIG. 6 shows an isometric illustration of a base ring of the switching valve.

FIG. 7 shows an isometric illustration of an actuator of the switching valve.

FIG. 8 shows an isometric illustration of a switching ring of the switching valve.

FIG. 9 shows an isometric illustration of the base ring with inserted switching ring of the switching valve.

### DETAILED DESCRIPTION

In the drawing figures, same or same-type components are identified with like reference characters. The drawing figures show only examples and are not to be understood as limiting.

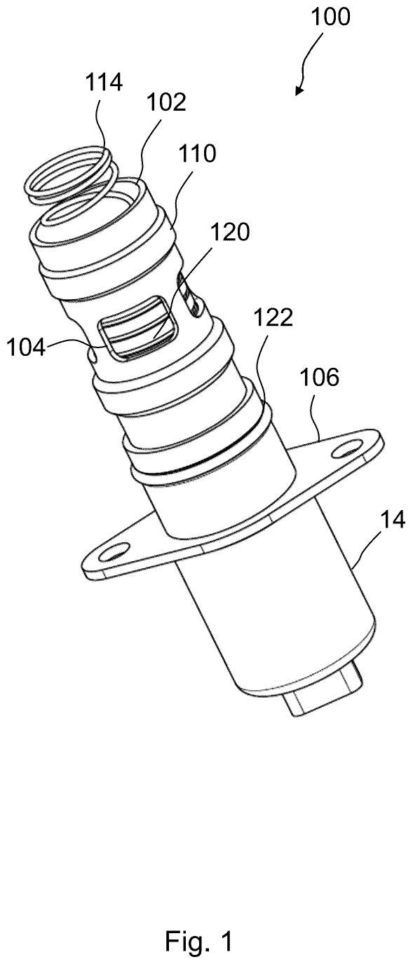

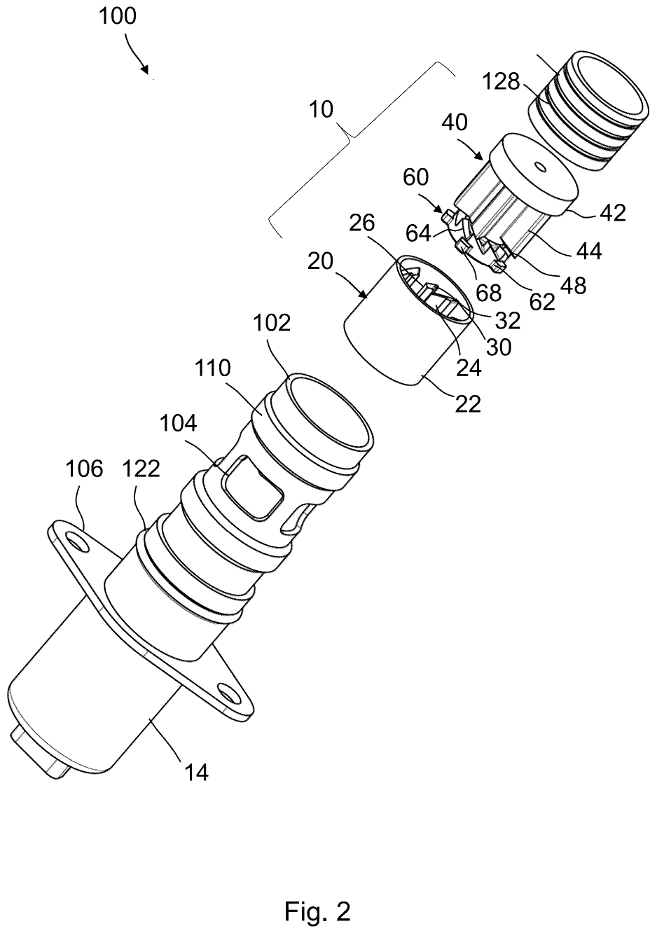

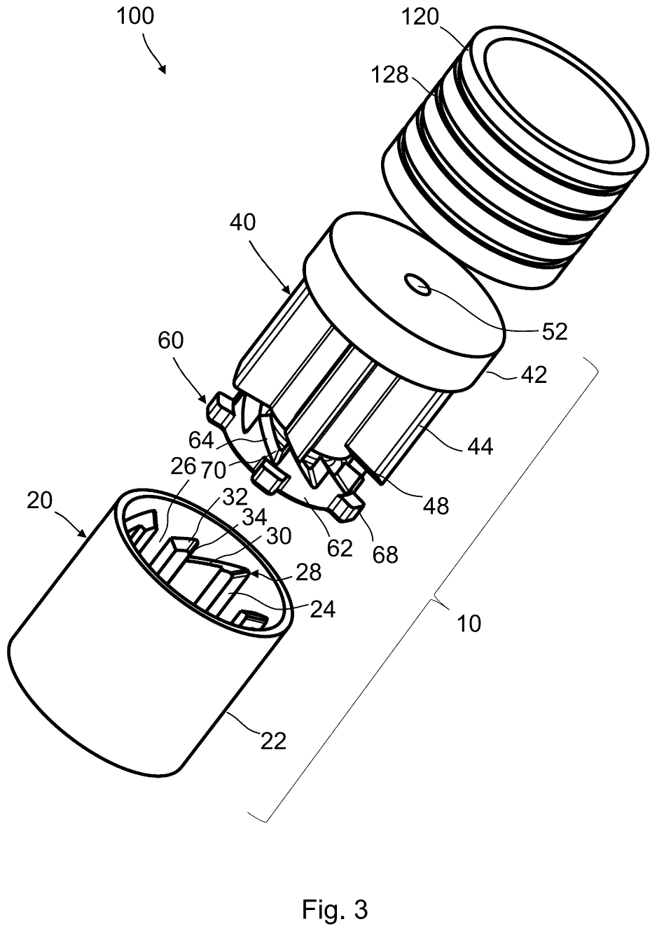

For explaining the invention, FIG. 1 shows an isometric illustration of a switching valve 100 for switching at least two fluid channels 202, 204 according to an embodiment of the invention. FIG. 2 shows an exploded illustration of the switching valve 100, wherein the part of the switching valve 100 with the switching unit 10 is illustrated enlarged in FIG. 3.

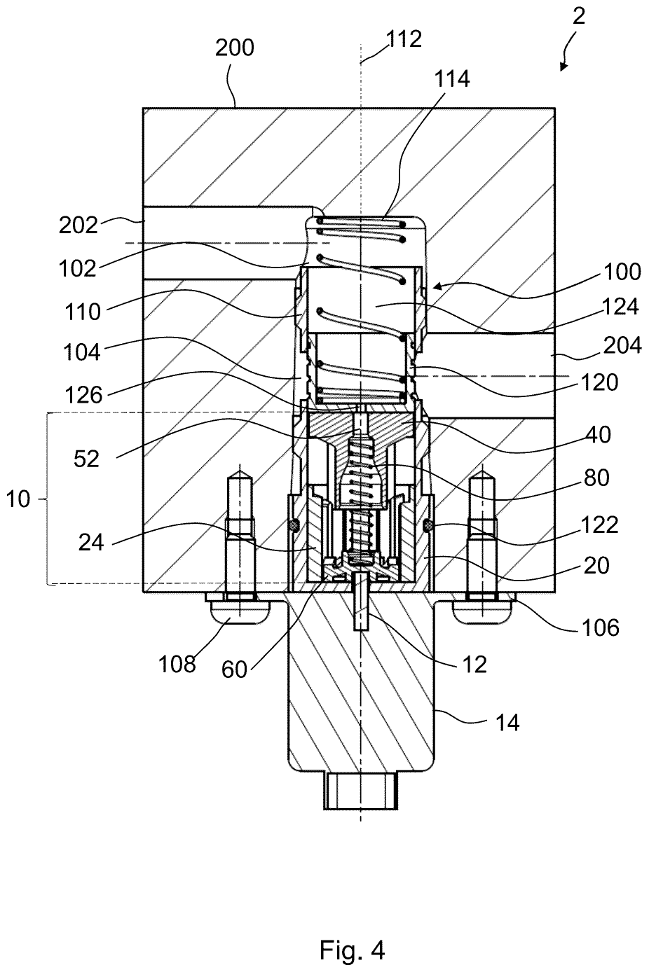

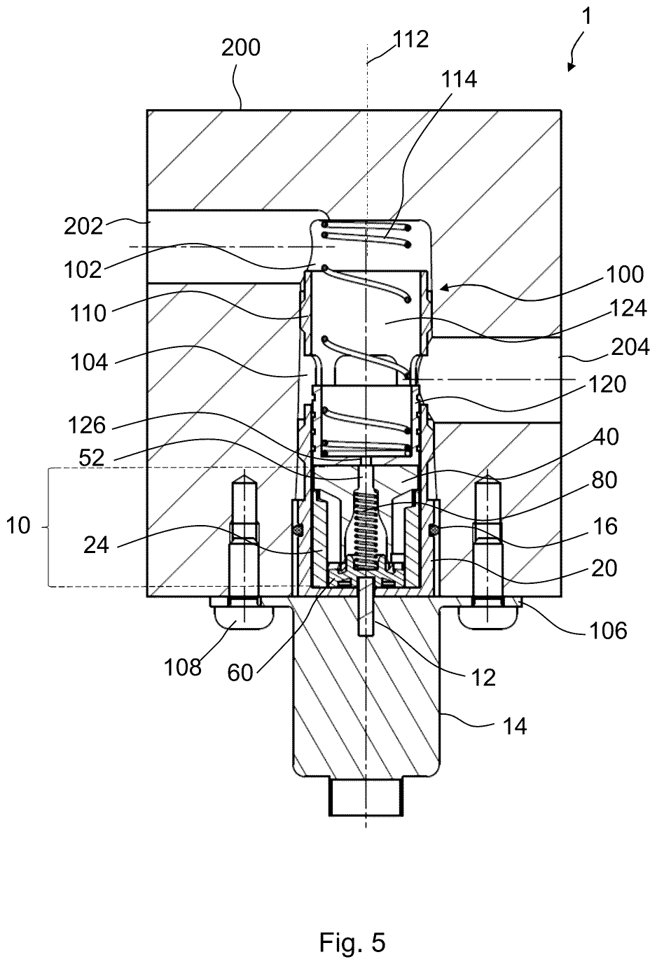

FIG. 4 shows in section illustration the switching valve 100 mounted in a valve block 200 in a second switching position 2 while FIG. 5 shows the switching valve 100 in a first switching position 1.

The switching valve 100 comprises a valve housing 110 in which a piston 120 is movably arranged in an axial direction 112 (FIG. 4) for controlling a fluid flow between at least two valve openings 102, 104. In use as intended, the valve openings 102, 104 are connected in fluid communication to the fluid channels 202, 204 of the valve block 200. Further, the switching valve 100 comprises a first restoring spring 114, by means of which the piston 120 in operation as intended is subjected to a restoring force in axial direction 112, and a switching unit 10 which is configured to move the piston 120, against the restoring force, from at least one first switching position 1 into at least one second switching position 2 and hold it, as well as return it from the at least one second switching position 2 into the at least one first switching position 1. In this context, the piston 120 is held without an energy supply, for example without electrical or magnetic energy, in the at least one first switching position 1 and the at least one second switching position 2.

The piston 120 comprises at its circumference circumferentially extending annular grooves 128, which, for example, are configured as lubricant grooves, in order to be guided within the valve housing 110 with minimal friction.

The switching valve 100 is arranged in a bore of the valve block 200 which intersects the two fluid channels 202, 204. The valve housing 110 is sealed by at least one radially outwardly arranged seal element 122, for example, an O-ring, against the bore of the valve block 200.

By action of a control pin 12 (see FIGS. 4 and 5) movable in axial direction 112, the switching unit 10 is configured to move the piston 120 from the at least one first switching position 1 into the at least one second switching position 2 and back. The control pin 12 may be coupled, for example, to a drive 14, for example an electromagnetic drive 14. The drive 14, as seen in FIG. 4, is screwed to the valve block 200 via fastening flange 106 by fastening screws 108. The control pin 12 may be a component of the drive 14. As an alternative, the control pin 12 may however be only driven by the drive 14.

The switching unit 10 comprises a base ring 20 with guide grooves 26 and holding ribs 24 arranged alternatingly at the inner circumference, as well as an actuator 40 which is guided in the base ring 20 in the guide grooves 26 in axial direction 112 and by means of which the piston 120 is movable in axial direction 112. The actuator 40 comprises first control surfaces 48 slanted in circumferential direction 36. Furthermore, the switching unit 10 comprises a switching ring 60 which is guided in the base ring 20 and is movable in axial direction 112 and comprises second control surfaces 64 complementary to the first control surfaces 48 in circumferential direction 36 and provided for contacting the first control surfaces 48. Furthermore, the switching unit 10 comprises a second restoring spring 80 by means of which the switching ring 60 is supported at the actuator 40 in axial direction 112.

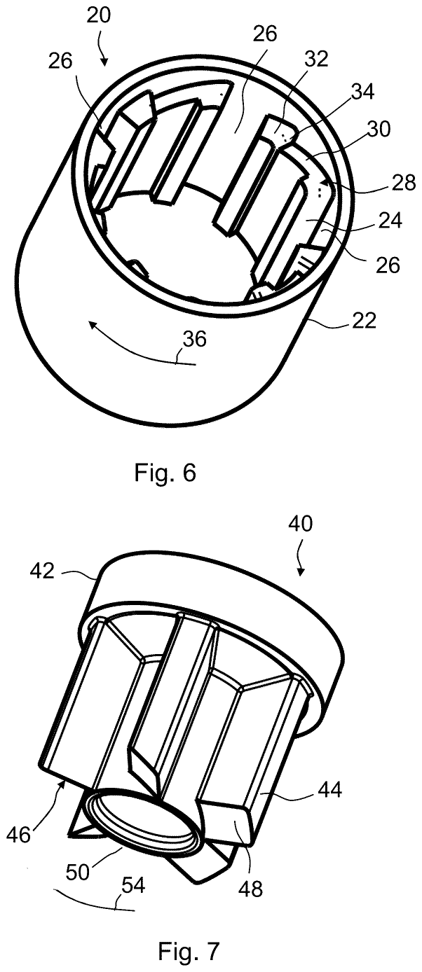

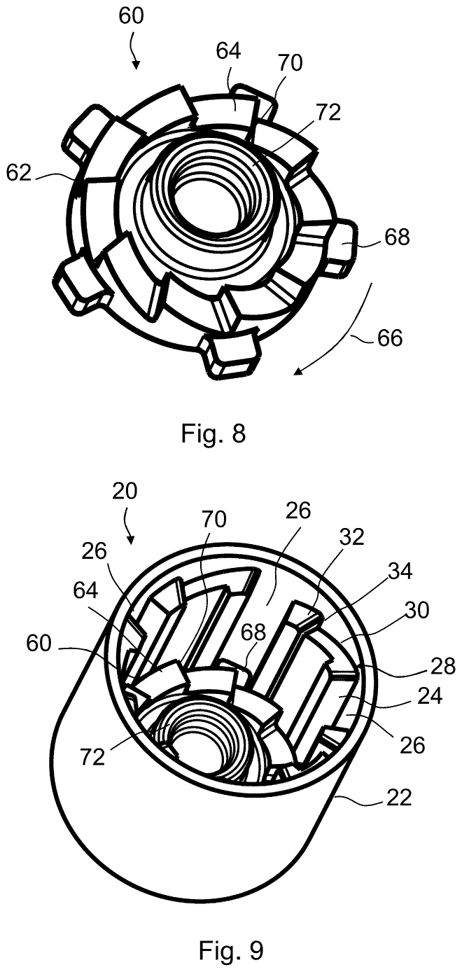

For illustrating the individual components of the switching unit 10, FIG. 6 illustrates an isometric illustration of the base ring 20 while FIG. 7 shows an isometric illustration of the actuator 40. FIG. 8 shows an isometric illustration of the switching ring 60 and FIG. 9 an isometric illustration of the base ring 20 with inserted switching ring 60.

The second control surfaces 64 of the switching ring 60 are configured in the circumferential direction 36 at least in sections wedge-shaped with intermediately positioned edges 70.

The switching ring 60 comprises radially protruding guide noses 68 which engage as intended the guide grooves 26 of the base ring 20. In this way, the switching ring 60 is laterally guided in the base ring 20.

At their axial free ends 28, the holding ribs 24 comprise locking surfaces 30 in which the actuator 40 is held in the at least one second switching position 2.

At a circumference 54, the actuator 40 comprises guide elements 44 extending in axial direction 112 and engaging as intended the guide grooves 26 of the base ring 20. In this way, the actuator 40 is laterally guided in the base ring 20.

At their axial free ends 46, the guide elements 44 comprise the first control surfaces 48.

The locking surfaces 30 of the base ring 20 comprise looking noses 32 arranged in circumferential direction 36 at which the guide elements 44 are locked in the at least one second switching position 2.

The switching ring 60 comprises a receptacle 72 and the actuator 40 an inner section 50 for guiding the second restoring spring 80.

The piston 120 and the actuator 40 each comprise a bore 52, 126 for compensation of a fluid volume upon a movement of piston 120 and actuator 40. In this way, fluid may flow from one side of the piston 120 through the bores 52, 126 to the other side of the actuator 40 and in reverse.

Assisted by the restoring force of the first restoring spring 114, the actuation of the control pin 12 by means of the switching valve 10 causes a simultaneous axial and rotary movement of the actuator 40 about the longitudinal axis 112. In this way, the actuator 40, which is, for example, in the switching position 1, is lifted out of the guide grooves 26 and held in the at least one second switching position 2 by the holding ribs 24 arranged at the base ring 20 and extending in axial direction 112.

Upon actuation of the control pin 12 in axial direction 112, the latter pushes on the switching ring 60. The switching ring 60 is thus moved so far in axial direction 112 until it impacts the actuator 40 which is guided in the base ring 20. The base ring 20 is press-fit and thus connected positionally fixed to the valve housing 110. As soon as the actuator 40 is moved out of the guide grooves 26 of the base ring 20, the restoring force of the first restoring spring 114 and the control surfaces 64 of the switching ring 60 which are slanted in circumferential direction 66 force the actuator 40 into a rotary movement. This rotation forces the actuator 40 into the next switching position 1, 2 and is held by the holding ribs 24 in the base ring 20 in this switching position 1, 2. When the actuator 40 is in this switching position 1, 2, the control pin 12 is without function. Therefore, no energy must be applied by the drive 14, the actuator 40 is thus held currentless in the switching position 1, 2.

The switching ring 60 is now forced into its basic position again by the second restoring spring 80.

As soon as a new control pulse is applied via the control pin 12 and the switching ring 60 again contacts the actuator 40, the actuator 40 is lifted out of the base ring 20 and rotates further. This time, the actuator 40 rotates so far that it jumps out of the holding ribs 24 and now may glide at the base ring 20 downwardly into the switching position 1. The switching valve 100 is opened thereby.

The slanted second control surfaces 64 effect namely that, due to renewed actuation of the switching ring 60 by the control pin 12, a rotary movement of the actuator 40 is effected again and the latter is lifted out of the holding ribs 24. In this way, the actuator 40 is returned by the restoring force of the first restoring spring 114 into the at least one first switching position 1.

Since the base ring 20 comprises alternatingly always a continuous guide groove 26 and a guide with holding rib 24, the switching valve 100 is alternatingly opened and closed.

In the switching position 2, which is illustrated in FIG. 4, the pushed-back piston 120 closes the fluid channel 204 so that no flow of fluid between the first fluid channel 202 and the second fluid channel 204 occurs.

In the switching position 1 which is illustrated in FIG. 5, the piston 120 is in a position between the two fluid channels 202, 204 so that the valve openings 104 are open toward the fluid channel 204. The valve opening 102 into the fluid channel 202 is always open so that fluid in the valve interior 124 flows through the hollow cylindrical piston 120 between the two fluid channels.

In an alternative embodiment, the holding ribs 24 may comprise at their axial free end 28 locking surfaces 30 which adjoin each other in circumferential direction 36 and which are arranged at different levels in the axial direction 112. In this way, a new switching position could be adjusted with every further switching impulse in the manner of a step switching action.

As indicated in FIGS. 2 to 5, the switching unit 10 comprises the base ring 20 with guide grooves 26 and holding ribs 24 alternatingly arranged at the inner circumference as well as the actuator 40 which is guided in the base ring 20 in axial direction 112 in the guide grooves 26 and by means of which the piston 120 is movable in axial direction 112. The actuator 40 comprises first control surfaces 48 slanted in circumferential direction 36. Furthermore, the switching unit 10 comprises the switching ring 60 which is guided in the base ring 20 and movable in axial direction 112 and comprises second control surfaces 64 complementary to the first control surfaces 48 in circumferential direction 36 and provided for contacting the first control surfaces 48. Furthermore, the switching unit 10 comprises the second restoring spring 80 by means of which the switching ring 60 is supported at the actuator 40 in axial direction 112.

The switching unit 10 could also be used as a retrofitting solution in order to convert a standard valve into a switching valve 100 with currentless switching position.

FIG. 6 shows an isometric illustration of the base ring 20 of the switching valve 100. The base ring 20 comprises an outer sleeve 22 in which, at an inner circumference, guide grooves 26 and holding ribs 24 are arranged alternatingly adjacently in axial direction.

The holding ribs 24 comprise at their axial free end 28 locking surfaces 30 in which the actuator 40 is held in the at least one second switching position 2. The locking surfaces 30 comprise locking noses 32 arranged in circumferential direction 36 at which guide elements 44 of the actuator 40 may be locked in the at least one second switching position 2. Between locking surfaces 30 and locking noses 32, an edge 34 may be seen, respectively, so that the guide elements 44 of the actuator 40 may remain locked at the locking surfaces 30 in the at least one second switching position 2.

FIG. 7 shows an isometric illustration of the actuator 40 of the switching valve 100. The actuator 40 comprises a body 42 with guide elements 44 extending in axial direction 112 at its circumference 54 and, as intended, engaging the guide grooves 26 of the base ring 20. In this way, the actuator 40 is guided laterally in the base ring 20. The guide elements 44 comprise the first control surfaces 48 at the axial free ends 46.

The actuator 40 comprises an inner section 50 for guiding the second restoring spring 80.

FIG. 8 shows an isometric illustration of the switching ring 60 of the switching valve 100. The switching ring 60, which is guided in the base ring 20 and is movable in axial direction 112, comprises in circumferential direction 66 at a ring body 62 second control surfaces 64 complementary to the first control surfaces 48 of the actuator 40 and provided for contacting the first control surfaces 48. Between the second control surfaces 64 slanted in circumferential direction 66, edges 70 are arranged, respectively, so that the guide elements 44 of the actuator 40 may remain locked at the second control surfaces 64 in the at least one first switching position 1.

The switching ring 60 comprises radially projecting guide noses 68 at the ring body 62 which, as intended, engage the guide grooves 26 of the base ring 20. In this way, the switching ring 60 may be guided laterally in the base ring 20.

FIG. 9 shows an isometric illustration of the base ring 20 with inserted switching ring 60 of the switching valve 100. In FIG. 9, the arrangement of the switching ring 60 in the base ring 20 may be seen. This switching ring 60 is arranged radially inside the holding ribs 24 of the base ring 20.

### REFERENCE CHARACTERS

1 first switching position
2 second switching position
10 switching unit
12 control pin
14 drive
20 base ring
22 sleeve
24 holding rib
26 guide groove
28 free end
30 locking surface
32 locking nose
34 edge
36 circumferential direction
40 actuator
42 body
44 guide element
46 free end
48 first control surface
50 inner section
52 bore
54 circumference
60 switching ring
62 ring body
64 second control surface
66 circumferential direction
68 guide nose
70 edge
72 receptacle
80 second restoring spring
100 switching valve
102 valve opening
104 valve opening
106 fastening flange
108 fastening screw
110 valve housing
112 axial direction (longitudinal axis)
114 first restoring spring
120 piston
122 seal element
124 valve interior
126 bore
128 annular groove
200 valve block
202 fluid channel
204 fluid channel

That which is claimed is:

1. A switching valve for switching at least two fluid channels, the switching valve comprising:
a valve housing comprising at least two valve openings;
a piston arranged in the valve housing so as to be movable in an axial direction and configured to control a fluid flow between the at least two valve openings, wherein the at least two valve openings are configured to be connected in fluid communication to the at least two fluid channels;
a first restoring spring configured to subject the piston to a restoring force in the axial direction; and
a switching unit configured to move the piston, against the restoring force, from at least one first switching position into at least one second switching position and to hold the piston in the at least one second switching position, wherein the switching unit is further configured to return the piston from the at least one second switching position into the at least one first switching position;
wherein the piston is held without a supply of energy in the at least one first switching position and in the at least one second switching position.

2. The switching valve according to claim 1, further comprising a control pin movable in the axial direction, wherein the switching unit is configured to move the piston from the at least one first switching position into the at least one second switching position and from the at least one second switching position back into the at least one first switching position by the control pin movable in the axial direction.

3. The switching valve according to claim 2, further comprising a drive, wherein the control pin is coupled to the drive.

4. The switching valve according to claim 3, wherein the drive is an electromagnetic drive.

5. The switching valve according to claim 2, wherein the switching unit comprises:
a base ring comprising guide grooves and holding ribs arranged alternatingly at an inner circumference of the base ring;
an actuator guided in the base ring in the guide grooves in the axial direction, wherein the actuator is configured to move the piston in the axial direction, and wherein the actuator comprises first control surfaces slanted in a circumferential direction of the actuator;
a switching ring guided in the base ring and movable in the axial direction, wherein the switching ring comprises second control surfaces complementary to the first control surfaces in the circumferential direction of the actuator and configured to contact the first control surfaces;
a second restoring spring supporting the switching ring at the actuator in the axial direction.

6. The switching valve according to claim 5, wherein the actuator, when the control pin is actuated, carries out a simultaneous axial and rotary movement around a longitudinal axis extending in the axial direction and is lifted out of the guide grooves and held in the at least one second switching position by the holding ribs of the base ring.

7. The switching valve according to claim 5, wherein the second control surfaces of the switching ring are wedge-shaped at least in sections in the circumferential direction.

8. The switching valve according to claim 5, wherein the switching ring comprises radially projecting guide noses engaging the guide grooves of the base ring.

9. The switching valve according to claim 5, wherein the holding ribs comprise axial free ends and the axial free ends comprise locking surfaces, and wherein the actuator is held at the locking surfaces in the at least one second switching position.

10. The switching valve according to claim 9, wherein the actuator comprises guide elements arranged at a circumference of the actuator and extending in the axial direction, and wherein the guide elements engage the guide grooves of the base ring.

11. The switching valve according to claim 10, wherein the first control surfaces of the actuator are arranged at axial free ends of the guide elements.

12. The switching valve according to claim 10, wherein the locking surfaces comprise locking noses arranged in a circumferential direction of the base ring, and wherein the guide elements are locked at the locking noses in the at least one second switching position.

13. The switching valve according to claim 9, wherein the locking surfaces adjoin each other in a circumferential direction of the base ring and are arranged at different levels in the axial direction.

14. The switching valve according to claim 5, wherein the piston and the actuator each comprise a bore configured to compensate a fluid volume in the switching valve upon movement of the piston and the actuator.

15. The switching valve according to claim 5, wherein the switching ring comprises a receptacle configured to guide the second restoring spring and/or the actuator comprises an inner section configured to guide the second restoring spring.

16. A switching unit for a switching valve, the switching unit comprising:
a base ring comprising guide grooves and holding ribs arranged alternatingly at an inner circumference of the base ring;
an actuator guided in the base ring in the guide grooves in an axial direction, wherein the actuator is configured to move a piston in the axial direction, and wherein the actuator comprises first control surfaces slanted in a circumferential direction of the actuator;
a switching ring guided in the base ring and movable in the axial direction, wherein the switching ring comprises second control surfaces complementary to the first control surfaces and configured to contact the first control surfaces; and
a second restoring spring supporting the switching ring at the actuator in the axial direction.

17. The switching unit according to claim 16, wherein the actuator carries out a simultaneous axial and rotary movement around a longitudinal axis extending in the axial direction and is lifted out of the guide grooves of the base ring and held by the holding ribs of the base ring.

18. The switching unit according to claim 16, wherein the holding ribs of the base ring comprise axial free ends and the axial free ends comprise locking surfaces, and wherein the actuator is held at the locking surfaces of the holding ribs of the base ring.

19. The switching unit according to claim 16, wherein the actuator comprises guide elements arranged at a circumference of the actuator and extending in the axial direction, and wherein the guide elements of the actuator engage the guide grooves of the base ring.

20. The switching unit according to claim 19, wherein the first control surfaces of the actuator are arranged at axial free ends of the guide elements.
